(19) United States
(12) Patent Application Publication
(10) Pub. No.: US 2016/0132211 A1
(43) Pub. Date: May 12, 2016

(54) METHOD AND APPARATUS FOR PROVIDING USER INTERFACE BY DISPLAYING POSITION OF HOVERING INPUT

(71) Applicant: HYUNDAI MOTOR COMPANY, Seoul (KR)

(72) Inventors: Seunghyun WOO, Seoul (KR); Daeyun AN, Anyang-si (KR)

(21) Appl. No.: 14/923,063

(22) Filed: Oct. 26, 2015

(30) Foreign Application Priority Data
Nov. 10, 2014 (KR) 10-2014-0155659

(51) Int. Cl. G06F 3/0481; G06F 3/0482; G06F 3/0488; G06F 3/0484

(52) U.S. Cl. CPC G06F 3/04812; G06F 3/04842; G06F 3/0482; G06F 3/04883; G06F 2203/04101; G06F 2203/04801

(57) ABSTRACT

An apparatus for providing a user interface includes a touch screen displaying one or more objects and detecting an approach or a touch of an input by a sensor. A controller is configured to determine the input approaching the touch screen as hovering on the touch screen and to provide a lighting effect on the touch screen based on a position of the hovering input.

### CROSS-REFERENCE TO RELATED APPLICATION

This application claims the benefit of priority to Korean Patent Application No. 10-2014-0155659 filed in the Korean Intellectual Property Office on Nov. 10, 2014, the entire content of which is incorporated herein by reference.

### TECHNICAL FIELD

The present disclosure relates to a method and an apparatus for providing a user interface. More particularly, the present disclosure relates a method and an apparatus for providing a user interface that improves recognition of a user by displaying a position of an input in a state of hovering.

### BACKGROUND

Recently, a vehicle is equipped with a display in a touch screen for displaying control menus of electronic devices. The touch screen has a user interface (UI) to recognize an input of a finger and the like. The input may be a direct contact of the finger or a non-contact input such as hovering.

However, the touch screen displaying the control menus of the electronic devices does not display the input. Accordingly, selecting the control menus may not be intuitive, thus deteriorating user convenience in operation of the electronic devices. Moreover, the user interface, which does not accurately recognize the input, may affect driving safety when the driver operates the control menus while driving.

Thus, the input should be easily recognized and manipulated to prevent distraction of a driver's attention. The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a method and an apparatus for providing a user interface having advantages of improving recognition of an input by displaying a position of the input in a state of hovering.

According to an exemplary embodiment of the present inventive concept, an apparatus for providing a user interface may include a touch screen displaying one or more objects and detecting an approach or a touch of an input by a sensor. A controller is configured to determine the input approaching the touch screen as hovering on the touch screen and to provide a lighting effect on the touch screen based on a position of the hovering input.

The controller may provide the lighting effect having a semi-transparent circular shape at a specific region on the touch screen.

When the position of the hovering input moves, the controller may provide the lighting effect at a moved region of the touch screen.

The controller may change an area of the lighting effect according to a distance between the hovering input and the touch screen.

The controller may change the area of the lighting effect to be inversely proportional to the distance between the hovering input and the touch screen.

The controller may change an area of the one or more displayed objects according to a distance between the hovering input and the touch screen when the hovering input interacts with the one or more displayed objects.

The controller may change the area of the one or more displayed objects to be inversely proportional to the distance between the hovering input and the touch screen.

According to another embodiment of the present inventive concept, a method for providing a user interface may include displaying the user interface including one or more objects on a touch screen. An input, which approaches to the touch screen, is determined as hovering on the touch screen. A lighting effect is provided at a specific region of the touch screen based on a position of the hovering input.

The lighting effect may have a semi-transparent circular shape.

The step of providing the lighting effect may include providing the lighting effect at a moving region according to a moving position of the hovering input.

The step of providing the lighting effect may include changing an area of the lighting effect according to a distance between the hovering input and the touch screen.

The area of the lighting effect may change to be inversely proportional to the distance between the hovering input and the touch screen.

The step of providing the lighting effect may include determining whether the hovering input interacts with the one or more displayed objects. An area of the one or more displayed objects is changed according to the distance between the hovering input and the touch screen when the hovering input interacts with the one or more displayed objects.

The area of the one or more displayed objects may change to be inversely proportional to the distance between the hovering input and the touch screen.

According to another embodiment of the present inventive concept, a method for providing a user interface may include outputting display information of a terminal to a screen of a vehicle when mirroring of the terminal is requested. Position information of an input is sent to the terminal. A lighting effect is provided at a specific region on the screen of the vehicle based on the position information of the input to the terminal.

The step of providing the lighting effect a may include generating position coordinates of the input and boundary coordinates including size information of a mirroring screen of the terminal. The lighting effect is provided at the specific region corresponding to the position coordinates of the input.

The lighting effect may have a semi-transparent circular shape.

As described above, according to the exemplary embodiment of the present inventive concept, recognizability and visibility of a display including a touch screen may be improved such that a user may easily operate the user interface of the display.

In addition, the user may quickly and accurately operate the user interface of the display by improving recognizability while mirroring the display of the portable terminal.

### BRIEF DESCRIPTION OF THE DRAWINGS

FIG. 1 is a schematic block diagram of an apparatus for providing a user interface according to an exemplary embodiment of the present inventive concept.

FIG. 2 is a flowchart showing a method for providing a user interface according to an exemplary embodiment of the present inventive concept.

FIG. 3 is a flowchart showing a method for providing a user interface according to another exemplary embodiment of the present inventive concept.

FIG. 4 is a diagram showing a lighting effect of a hovering input on a touch screen according to an exemplary embodiment of the present inventive concept.

FIG. 5 is a diagram showing a lighting effect that is changed in area thereof according to an exemplary embodiment of the present inventive concept.

FIG. 6 is a diagram showing a displayed object changed in area thereof according to an exemplary embodiment of the present inventive concept.

FIG. 7 is a diagram showing a lighting effect during mirroring according to an exemplary embodiment of the present inventive concept.

### DETAILED DESCRIPTION OF THE EMBODIMENTS

In the following detailed description, only certain exemplary embodiments of the present inventive concept have been shown and described, simply by way of illustration. As those skilled in the art would realize, the described embodiments may be modified in various different ways, all without departing from the spirit or scope of the present inventive concept.

In this specification, unless explicitly described to the contrary, the word “comprise” and variations such as “comprises” or “comprising” will be understood to imply the inclusion of stated elements but not the exclusion of any other elements. In addition, the terms “-er,” “-or,” and “module” described in the specification mean units for processing at least one function and operation, and can be implemented by hardware components or software components and combinations thereof.

The drawings and description are to be regarded as illustrative in nature and not restrictive. Like reference numerals designate like elements throughout the specification.

Throughout this specification and the claims which follow, “hovering” means a touch being recognized by an input such as a finger of a user or a touch pen approaching a display device. The touch, which is recognized when the input such as the finger or the touch pen contacts a surface of the display device, is called a “surface touch”, unlike the hovering. The surface touch may be detected by a touch sensor included in the display device. The touch sensor is configured to convert a pressure applied to a predetermined point or a change in capacitance generated at the predetermined point into an electric input signal.

An exemplary embodiment of the present inventive concept will hereinafter be described in detail with reference to the accompanying drawings.

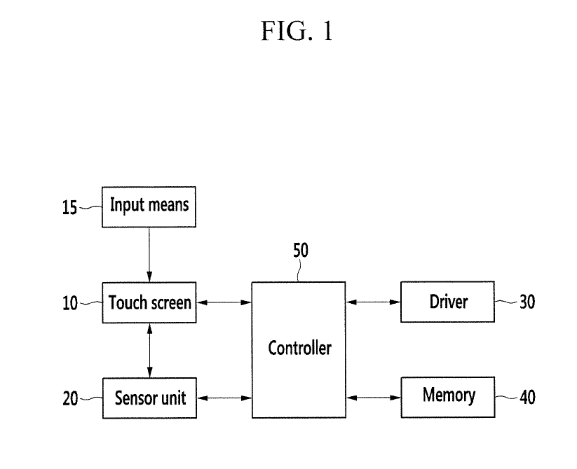

FIG. 1 is a schematic block diagram of an apparatus for providing a user interface according to an exemplary embodiment of the present inventive concept.

The apparatus for providing a user interface according to an exemplary embodiment of the present inventive concept may be provided on an audio video navigation (AVN) system or a center fascia in a vehicle.

As shown in FIG. 1, an apparatus for providing a user interface according to an exemplary embodiment of the present inventive concept includes a touch screen 10, a sensor 20, a driver 30, a memory 40, and a controller 50. Constituent elements of FIG. 1 are not essential elements, and thus, the apparatus for providing a user interface according to the exemplary embodiment of the present inventive concept may include more or less constituent elements than those of FIG. 1.

The touch screen 10 may have a layer structure with a touch pad and a display module.

The touch pad may be a resistive touch pad, a capacitive touch pad, an infrared touch pad, an electromagnetic induction touch pad, an ultrasonic touch pad, etc. The touch screen 10 may detect approaching, receding, moving, and touch of an input 15. In addition, the touch screen 10 may generate a signal corresponding to detection of the input 15 and transmit the signal to the controller 50.

The display module may display information processed by the controller 50. Therefore, the touch screen 10 may display one or more objects of the user interface including menus associated with various functions through the display module.

The input 15 is a user input means controlled by a user, for example, a finger or a touch pen.

The sensor 20 may include at least one of a capacitive touch sensor, an impedance touch sensor, a pressure sensor, and a proximity sensor. Therefore, the sensor 20 may detect a touch or an approach of the input 15 and transmit a detection signal to the controller 50.

The driver 30 may receive various control signals from the controller 50 to control various electronic devices, such as an air conditioner, a navigation device, and a multi-media device of a vehicle.

The memory 40 may include programs to operate the controller 50 and various data to be processed by the controller 50. In addition, the memory 40 may store data associated with the one or more objects displayed on the touch screen 10.

For example, the memory 40 may store graphics data for displaying the one or more objects of the user interface, connection information between the one or more objects, and setting information of the user interface.

The controller 50 allows the input 15 to hover on the touch screen 10, and provides a lighting effect at the touch screen 10 based on a position of the hovering input 15. Herein, the controller 50 may provide the lighting effect having a semi-transparent circular shape at a specific region on the touch screen 10.

The controller 50 may provide the lighting effect at a moved region of the touch screen 10 when the position of the hovering input 15 moves. The controller 50 may provide the lighting effect of which brightness, chroma, and transparency are different between a start point and an end point after moving.

In addition, the controller 50 may change an area of the lighting effect according to a distance between the hovering input 15 and the touch screen 10. Herein, the area of the lighting effect may be inversely proportional to the distance between the hovering input 15 and the touch screen 10.

The controller 50 may change an area of the one or more displayed objects according to the distance between the hovering input 15 and the touch screen 10 when the hovering input 15 interacts with the one or more displayed objects. Herein, the area of the one or more displayed objects may be inversely proportional to the distance between the hovering input 15 and the touch screen 10.

The controller 50 may be implemented as at least one microprocessor that is operated by a predetermined program, and the predetermined program may be programmed in order to perform each step of a method for providing a user interface according to an exemplary embodiment of the present inventive concept.

Various embodiments described herein may be implemented within a recording medium that may be read by a computer or a similar device by using software, hardware, or a combination thereof, for example.

According to hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units designed to perform any other functions.

According to software implementation, embodiments such as procedures and functions described in the present embodiments may be implemented by separate software modules. Each of the software modules may perform one or more functions and operations described in the present invention. A software code may be implemented by a software application written in an appropriate program language.

Hereinafter, a method for providing a user interface according to an exemplary embodiment of the present invention will be described in detail with reference to the accompanying drawings.

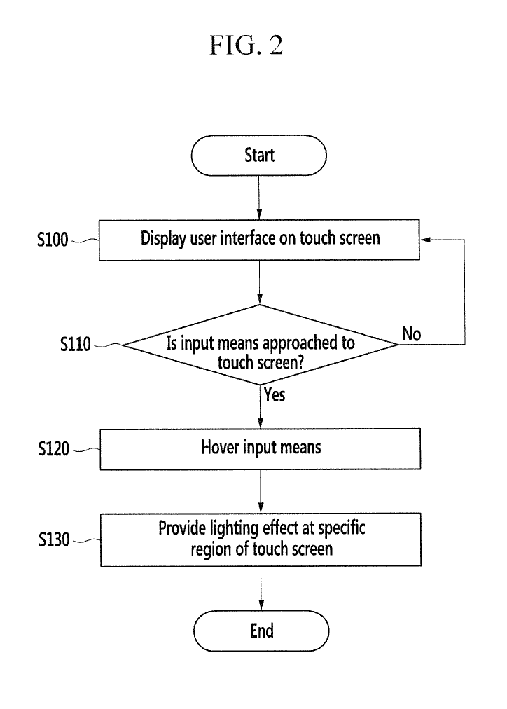

FIG. 2 is a flowchart showing a method for providing a user interface according to an exemplary embodiment of the present inventive concept.

As shown in FIG. 2, a method for providing a user interface according to an exemplary embodiment of the present inventive concept includes displaying a user interface including one or more objects on the touch screen 10 at step S100.

When the user interface is displayed on the touch screen 10 at step S100, the sensor 20 detects an approach of the input 15 at step S110. Whether the input 15 approaches the touch screen 10 may be determined by a distance between the touch screen 10 and the input 15.

When the input 15 approaches the touch screen 10 at step S110, the controller 50 allows the input 15 to hover on the touch screen 10 at step 5120. A hovering recognition distance may be changed according to an operation of a user. For example, the hovering recognition distance at night may be longer than the hovering recognition distance at daytime so as to easily recognize the approach of the input 15 during the night.

When the input 15 hovers at the step S120, the controller 50 provides a lighting effect at a specific region on the touch screen 10 based on a position of the hovering input 15 at step S130.

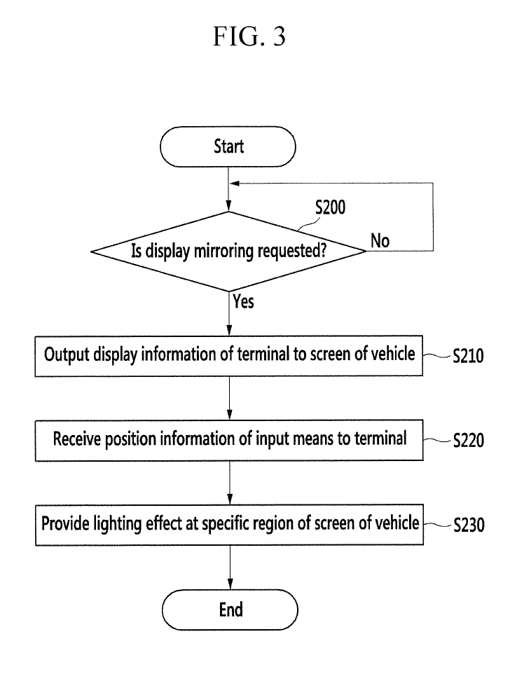

FIG. 3 is a flowchart showing a method for providing a user interface according to another exemplary embodiment of the present inventive concept.

A method for providing a user interface according to another exemplary embodiment of the present inventive concept includes an image display device of a vehicle and a portable terminal.

In this specification, the image display device of the vehicle may include an entire display device outputting the image such as a TV and an audio video and navigation AVN system.

In addition, in this specification, the portable terminal may include an entire terminal that can perform data communication connecting to the image display device such as a mobile phone, a smart phone, a personal digital assistant (PDA), and a portable multimedia player (PMP).

The image display device is connected to the portable terminal by wire or wireless and performs mutual data communication. That is, the image display device and the portable terminal are configured to transmit and receive data.

A method for connecting the image display device and the portable terminal may use various techniques such as a universal serial bus (USB), a wireless LAN, a wireless broadband, Bluetooth, and an infrared data association.

The image display device of the vehicle may share a screen with the portable terminal through data communication. That is, the image display device may receive screen information of the portable terminal and output the same information on the screen thereof. Accordingly, the user may see the same screen from two devices.

Sharing the same screen between two devices is referred as mirroring. The mirroring may be done by a source device providing screen information and a sink device outputting same screen information. That is, the mirroring may display a screen of the source device at the sink device.

As shown in FIG. 3, a method for providing a user interface according to another exemplary embodiment of the present inventive concept includes determining whether mirroring of the portable terminal is requested at step S200.

When the mirroring of the portable terminal is requested at the step S200, the controller 50 outputs display information of the portable terminal to a screen of the vehicle at step S210.

Simultaneously, the controller 50 receives position information of the input 15 to the portable terminal at step S220.

When the position information of the input 15 to the portable terminal is inputted at the step S220, the controller 50 provides a lighting effect at a specific region on the screen of the vehicle based on the position information of the input 15 to the portable terminal at step S230.

That is, the controller 50 may generate position coordinates of the input 15 and boundary coordinates including size information of a mirrored screen of the portable terminal, and then the controller 50 may provide the lighting effect at the specific region corresponding to the position coordinate of the input 15.

Hereinafter, a state in which a lighting effect based on a position of a hovering input s according to an exemplary embodiment of the present inventive concept will be described with reference to accompanying drawings.

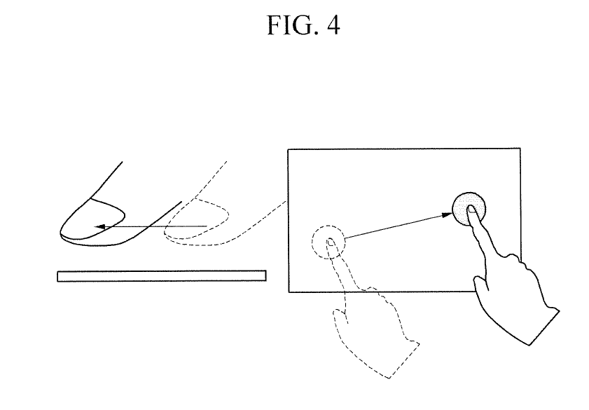

FIG. 4 is a diagram showing a lighting effect of a hovering input on a touch screen according to an exemplary embodiment of the present inventive concept.

As shown in FIG. 4, according to an exemplary embodiment of the present inventive concept, a hovering position and a path of a finger of a user on the touch screen 10 may be provided as a lighting effect, thus improving recognition of the user. The lighting effect may have a semi-transparent circular shape. In addition, a color of the lighting effect may change depending on a color of a displayed object on the touch screen 10.

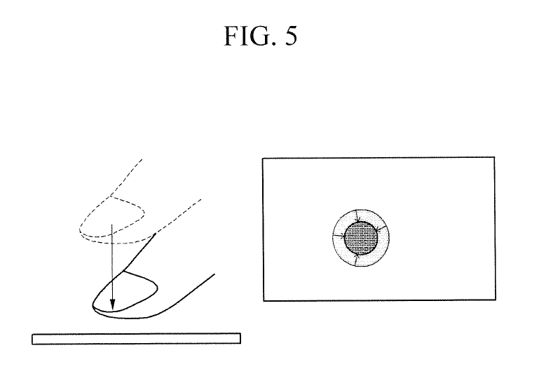

FIG. 5 is a diagram showing a changed area of a lighting effect according to an exemplary embodiment of the present inventive concept.

As shown in FIG. 5, according to an exemplary embodiment of the present inventive concept, an area of the lighting effect may be changed according to a distance between the hovering input 15 and the touch screen 10. The area of the lighting effect may change to be inversely proportional to a distance between the hovering input 15 and the touch screen 10. That is, the area may become larger as the distance between the hovering input 15 and the touch screen 10 becomes shorter.

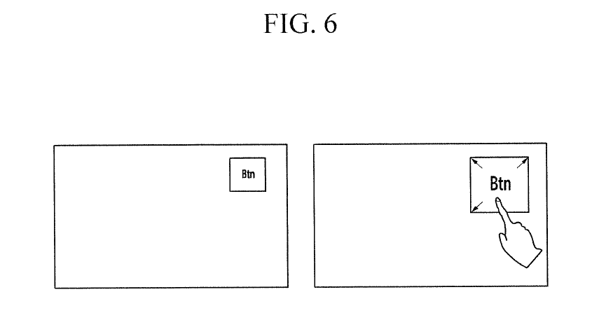

FIG. 6 is a diagram showing a changed area of a displayed object according to an exemplary embodiment of the present inventive concept.

As shown in FIG. 6, according to an exemplary embodiment of the present inventive concept, an area of a displayed object may change according to a distance between the hovering input 15 and the touch screen 10 when the hovering input 15 interacts with the displayed object. The area of the displayed object may change to be inversely proportional to the distance between the hovering input 15 and the touch screen 10. That is, the area of the displayed object may become larger as the distance between the hovering input 15 and the touch screen 10 becomes shorter.

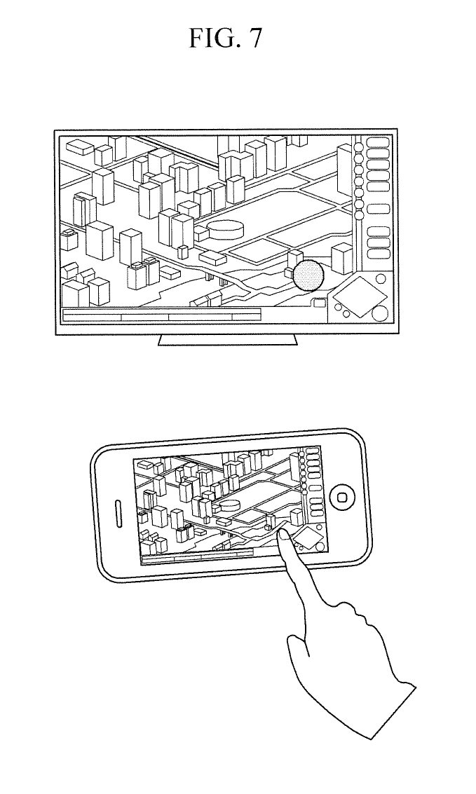

FIG. 7 is a diagram showing a lighting effect during mirroring according to an exemplary embodiment of the present inventive concept.

As shown in FIG. 7, according to an exemplary embodiment of the present inventive concept, a lighting effect may be provided at an image display device of a vehicle in a state of mirroring based on position information of the input 15 to the terminal.

As described above, according to the exemplary embodiment of the present inventive concept, recognizability and visibility of a display including a touch screen may be improved such that a user may easily operate a user interface of the display. In addition, the user may quickly and accurately operate the user interface of the display by improving the recognizability while operating a mirrored display of the portable terminal.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. An apparatus for providing a user interface, comprising:
a touch screen displaying one or more objects and detecting an approach or a touch of an input by a sensor; and
a controller configured to determine the input approaching the touch screen as hovering on the touch screen and to provide a lighting effect on the touch screen based on a position of the hovering input.

2. The apparatus of claim 1, wherein the controller provides the lighting effect having a semi-transparent circular shape at a specific region on the touch screen.

3. The apparatus of claim 1, wherein, when the position of the hovering input moves, the controller provides the lighting effect at a moved region of the touch screen.

4. The apparatus of claim 1, wherein the controller changes an area of the lighting effect according to a distance between the hovering input and the touch screen.

5. The apparatus of claim 4, wherein the controller changes the area of the lighting effect to be inversely proportional to the distance between the hovering input and the touch screen.

6. The apparatus of claim 1, wherein the controller changes an area of the one or more displayed objects according to a distance between the hovering input and the touch screen when the hovering input interacts with the one or more displayed objects.

7. The apparatus of claim 6, wherein the controller changes the area of the one or more displayed objects to be inversely proportional to the distance between the hovering input and the touch screen.

8. A method for providing a user interface, comprising steps of:
displaying, by a controller, the user interface including one or more objects on a touch screen;
determining, by the controller, an input approaching the touch screen as hovering on the touch screen; and
providing, by the controller, a lighting effect at a specific region on the touch screen based on a position of the hovering input.

9. The method of claim 8, wherein the lighting effect has a semi-transparent circular shape.

10. The method of claim 8, wherein the step of providing the lighting effect comprises:
providing, when the position of the hovering input moves, the lighting effect at a moved region.

11. The method of claim 8, wherein the step of providing the lighting effect comprises:
changing an area of the lighting effect according to a distance between the hovering input and the touch screen.

12. The method of claim 11, wherein the area of the lighting effect changes to be inversely proportional to the distance between the hovering input and the touch screen.

13. The method of claim 8, wherein the step of providing the lighting effect comprises:
determining whether the hovering input interacts with the one or more displayed objects; and
changing an area of the one or more displayed objects according to a distance between the hovering input and the touch screen when the hovering input interacts with the one or more displayed objects.

14. The method of claim 13, wherein the area of the one or more displayed objects changes to be inversely proportional to the distance between the hovering input and the touch screen.

15. A method for providing a user interface, comprising steps of:
outputting, by a controller, display information of a terminal to a screen of a vehicle when mirroring of the terminal is requested;
transmitting, by a controller, position information of an input to the terminal; and
providing, by a controller, a lighting effect at a specific region on the screen based on the position information to the terminal.

16. The method of claim 15, wherein the step of providing the lighting effect comprises:
generating position coordinates of the input and boundary coordinates including size information of a mirrored screen of the terminal; and
providing the lighting effect at the specific region corresponding to the position coordinates of the input.

17. The method of claim 15, wherein the lighting effect has a semi-transparent circular shape.

18. The method of claim 16, wherein the step of providing the lighting effect at the specific region comprises:
providing, when the position coordinates of the input moves, the lighting effect at a moved region.
